(19) United States
(12) Patent Application Publication
(10) Pub. No.: US 2026/0225684 A1
(43) Pub. Date: Aug. 6, 2026

(54) HYDRAULIC BRAKING DEVICE, HYDRAULIC BRAKING OPERATION DEVICE, AND BICYCLE

(71) Applicant: S-Ride Bicycle Components(Foshan) Co., Ltd., Foshan City, Guangdong Province (CN)

(72) Inventors: Weibing LIU, Foshan City (CN); Zhimin MENG, Foshan City (CN); Wei LIU, Foshan City (CN); Bo SONG, Foshan City (CN)

(73) Assignee: S-Ride Bicycle Components(Foshan) Co., Ltd., Foshan City, Guangdong Province (CN)

(21) Appl. No.: 19/152,950

(22) PCT Filed: Aug. 29, 2024
(86) PCT No.: PCT/CN2024/115673

§ 371 Date: Aug. 1, 2025

(30) Foreign Application Priority Data
Aug. 30, 2023 (CN) 202322348206.0
Aug. 30, 2023 (CN) 202322348211.1

(51) Int. Cl. B62L 3/02

(52) U.S. Cl. CPC B62L 3/023

(57) ABSTRACT

Disclosed are a hydraulic braking device, a hydraulic braking operation device, and a bicycle. The hydraulic braking device includes a cylinder body, a push rod piston, and a reset spring. One end of the push rod piston reciprocates in the cylinder body by overcoming the elastic force of the reset spring. A push rod head is provided on the other end of the push rod piston. The hydraulic braking operation device includes a support, an operating lever, and the hydraulic braking device, the operating lever being rotatably connected to the support; the hydraulic braking device is of a symmetrical structure and is provided inside the support; a driving rod is arranged on the support.

### CROSS-REFERENCE TO RELATED APPLICATIONS

This is the U.S. National Stage of International Patent Application No. PCT/CN2024/115673 filed on Aug. 29, 2024, which claims the right of priority of Chinese Patent Application 202322348206.0 filed Aug. 30, 2023 and Chinese Patent Application 202322348211.1 filed Aug. 30, 2023.

### TECHNICAL FIELD

The present disclosure relates to the technical field of bicycle braking devices, and in particular, to a hydraulic braking device for bicycle hydraulic braking and a bicycle.

### BACKGROUND

In recent years, the bicycle market has been booming. Both high-end racing bicycles and mass-market bicycles for commuting and leisure have gained widespread consumer preference. Bicycle braking methods are generally categorized into cable-actuated braking and hydraulic braking. The braking principle of hydraulic braking is as follows. When the operating lever is rotated, it pushes a transmission component to move, driving the push rod piston within the hydraulic braking device to move. Alternatively, the operating lever directly pushes the push rod piston in the hydraulic braking device to move. The push rod piston then compresses the hydraulic fluid within the hydraulic braking device, forcing the hydraulic fluid to drive the movement of the brake caliper, thereby achieving braking.

In the prior hydraulic braking devices, the push rod piston is in direct contact with a transmission component or the operating lever. With prolonged use, contact areas between the push rod piston and the transmission component or the operating lever are prone to wear, resulting in damage to the push rod piston and affecting braking. Direct replacement of the push rod piston is costly and inconvenient for maintenance. In addition, the prior hydraulic braking device is installed at the head of the operating lever, resulting in an increased volume of the head of the operating lever and a more complex structure. This makes the grip uncomfortable when gripping the upper grip position. Furthermore, bicycles are generally provided with two hydraulic braking devices, and the two hydraulic braking devices are not universal and thus cannot be interchanged.

### SUMMARY

The purpose of the present disclosure is to overcome the above-mentioned problems and provide a hydraulic braking device for bicycle hydraulic braking. The hydraulic braking device does not come into direct contact with a transmission component or an operating lever, so that the wear of a push rod piston may be avoided, and the maintenance is very convenient without the need to replace the push rod piston.

Another object of the present disclosure is to provide a hydraulic braking device for bicycle hydraulic braking.

Yet another object of the present disclosure is to provide a bicycle that includes the hydraulic braking device described above.

The objects of the present disclosure are realized by the following technical solutions.

A hydraulic braking device for bicycle hydraulic brake, including a cylinder body, a push rod piston, and reset springs; where one end of the push rod piston reciprocates in the cylinder body by overcoming an elastic force of the reset spring; and a push rod head is provided on the other end of the push rod piston.

In some embodiments, the push rod head and the push rod piston are connected through a detachable structure.

In some embodiments, the detachable structure is one of an interference fit structure, a threaded connection structure, or a bonding structure.

In some embodiments, the interference fit structure includes a mounting hole provided on the push rod piston and a mounting rod provided on the push rod head, and the mounting hole is in an interference fit with the mounting rod.

In some embodiments, the push rod head is integrally provided with the mounting rod.

In some embodiments, the threaded connection structure includes a threaded hole provided on the push rod piston and a threaded rod provided on the push rod head, and the threaded rod is in mating engagement with the threaded hole.

In some embodiments, the hydraulic braking device is a symmetrical structure.

In some embodiments, the push rod head is a metal push rod head, and the piston is a plastic push rod piston.

In some embodiments, the hydraulic braking device further includes a breather rubber and a sealing cover; the cylinder body is provided with an oil cylinder and an oil compensation chamber; the oil compensation chamber is in communication with the oil cylinder; and the push rod piston is slidably connected with the oil cylinder. The breather rubber is provided at the upper end of the oil compensation chamber; the sealing cover is provided at the upper end of the breather rubber; the sealing cover is fixedly connected to the cylinder body; and the sealing cover is provided with a ventilation hole. The front end of the cylinder body is provided with an oil filler hole, and the oil filler hole is in communication with the oil compensation chamber. An opening of the oil filler hole is provided with a sealing bolt, and the sealing bolt is configured to install the sealing cover on the cylinder body and to seal the oil filler hole. The rear end of the cylinder body and the sealing cover are fixed by a fixing screw. The cylinder body is symmetrically provided with two oil outlet holes; the two oil outlet holes are in communication with the oil cylinder; and an outlet of the oil outlet hole is sealed by a sealing member. The oil cylinder and the oil compensation chamber communicate with each other through an oil compensation hole and a lubricating oil hole.

A bicycle hydraulic braking operation device, including a support, an operating lever, and the above-mentioned hydraulic braking device.

The operating lever is rotatably connected to the support; the hydraulic braking device is a symmetrical structure and is provided inside the support; a driving rod is provided on the support; the head end of the driving rod is in contact with the operating lever; the tail end of the driving rod is in contact with the hydraulic braking device; and the driving rod is configured to receive a driving force from the operating lever.

In some embodiments, the driving rod is rotatably provided on the support; the head end and the tail end of the driving rod are each provided with a rolling member; the rolling member at the head end is in contact with the operating lever; and the rolling member at the tail end is in contact with the hydraulic braking device.

In some embodiments, the rolling member is a rolling bearing.

In some embodiments, the head of the operating lever is provided with a speed-changing operation device.

In some embodiments, the operating lever includes a base and a lever body; the base is rotatably provided on the support; the lever body is rotatably provided on the base; and the rolling member at the head end of the driving rod is in contact with the base.

In some embodiments, the base is provided with an extended drive portion, and the extended drive portion is in contact with the rolling member at the head end of the driving rod.

In some embodiments, the support is provided with an installation inner cavity; and the hydraulic braking device is fixed in the installation inner cavity through a positioning shaft.

In some embodiments, the tail end of the driving rod is in contact with the push rod piston.

A bicycle, including the above-mentioned hydraulic braking device.

A bicycle, including the above-mentioned hydraulic braking operation device.

Compared with the prior art, the present disclosure has the following beneficial effects.
1. The hydraulic braking device of the present disclosure is provided with a push rod head on the push rod piston, such that the push rod piston may be prevented from directly contacting the transmission component or the operating lever during braking, thereby avoiding wear of the push rod piston.
2. In the hydraulic braking device of the present disclosure, during braking, the push rod head directly contacts the transmission components or the operating lever. In the event of wear over long-term use, the push rod head may be directly replaced without the need to replace the push rod piston. This makes maintenance very convenient and reduces maintenance costs.
3. In the hydraulic braking device of the present disclosure, the hydraulic braking device is installed inside the support, so that the hydraulic braking operation device has a high overall strength, a simpler structure, and a smaller volume. During braking, operating the operating lever does not affect the grip feel when gripping the handlebar in the hood position, thereby improving the safety and comfort of braking on road bicycles.
4. In the hydraulic braking device of the present disclosure, the hydraulic braking device is independently installed inside the support, making it easy to disassemble, replace, and maintain.
5. In the hydraulic braking device of the present disclosure, the hydraulic braking device is a symmetrical structure and may be universally installed on the supports at the left and right ends of the bicycle handlebar, enhancing compatibility and reducing manufacturing complexity.

### BRIEF DESCRIPTION OF THE DRAWINGS

FIGS. 1 to 3 are schematic structural diagrams of a specific implementation of a hydraulic braking device for bicycle hydraulic braking according to the present disclosure, where FIG. 1 is a perspective view, FIG. 2 is a top view, and FIG. 3 is a cross-sectional view.

FIG. 4 is an exploded view of a push rod piston and a push rod head according to the present disclosure.

FIG. 5 is a schematic structural diagram of a hydraulic braking device in a working state according to the present disclosure.

FIG. 6 is a schematic structural diagram of a specific implementation of a hydraulic braking operation device for a road bicycle according to the present disclosure.

FIG. 7 is a schematic diagram of an internal structure of a hydraulic braking operation device according to the present disclosure, with a line hidden.

FIGS. 8 to 11 are schematic structural diagrams of a hydraulic braking operation device according to the present disclosure, with a line and a support hidden, where FIG. 8 is a front view, FIGS. 9 to 10 are perspective views from different viewing directions, and FIG. 11 is an exploded view.

FIG. 12 is a three-dimensional structural diagram of a driving rod according to the present disclosure.

FIG. 13 is a three-dimensional structural diagram of a driving rod equipped with a sleeve according to the present disclosure.

FIG. 14 is a schematic structural diagram of connection between a hydraulic braking device and a line according to the present disclosure.

FIG. 15 is a cross-sectional view of a hydraulic braking device according to the present disclosure.

### DETAILED DESCRIPTION

In order to enable those skilled in the art to fully understand the technical solutions of the present disclosure, the present disclosure will be further described below in conjunction with embodiments and drawings. However, implementations of the present disclosure are not limited thereto.

An embodiment of the present disclosure provides a hydraulic braking operation device for bicycle hydraulic braking, including a support 1, an operating lever 2, and a hydraulic braking device 3. The operating lever 2 is rotatably connected to the support 1; the hydraulic braking device 3 is provided inside the support 1; the support 1 is provided with a driving rod 4; and the head end of the driving rod 4 is in contact with the operating lever 2. The tail end of the driving rod 4 is in contact with the hydraulic braking device 3, and the driving rod 4 is configured to receive a driving force from the operating lever 2.

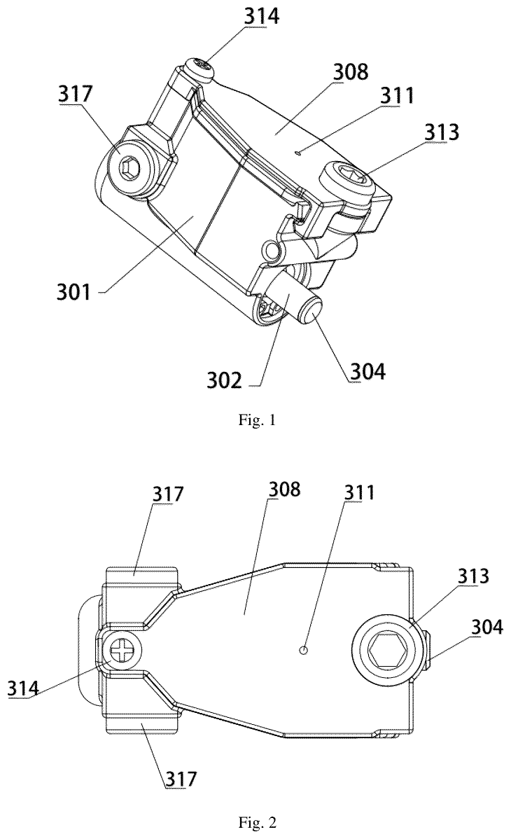

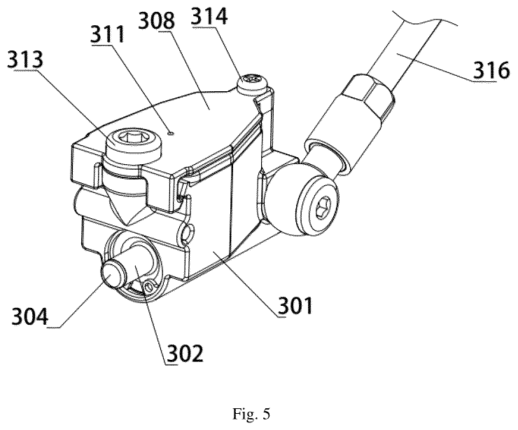

Referring to FIGS. 1 to 5, the hydraulic braking device 3 includes a cylinder body 301, a push rod piston 302, and a reset spring 303. One end of the push rod piston 302 reciprocates in the cylinder body 301 by overcoming an elastic force of the reset spring 303. A push rod head 304 is provided on the other end of the push rod piston 302.

Referring to FIGS. 1 to 5, the push rod head 304 and the push rod piston 302 are connected through a detachable structure. The purpose is to facilitate easy disassembly and separation of the push rod head 304 from the push rod piston 302 through the detachable structure. When the push rod head 304 is worn out due to friction, the push rod head 304 may be directly disassembled and replaced with a new push rod head 304, which is cost-effective and convenient for maintenance.

Referring to FIGS. 1 to 5, the push rod head 304 and the push rod piston 302 are coaxially provided.

Referring to FIGS. 1 to 5, the detachable structure is an interference fit structure. By providing the interference fit structure, the installation stability is improved, and the disassembly is also very convenient.

Referring to FIGS. 1 to 5, the interference fit structure includes a mounting hole 305 provided on the push rod piston 302 and a mounting rod 306 provided on the push rod head 304, and the mounting hole 305 is in an interference fit with the mounting rod 306. By providing the mounting rod 306 and the mounting hole 305, the design not only facilitates machining but also simplifies the installation process. The mounting rod 306 may be directly inserted into the mounting hole 305, and it is very stable after installation. When disassembly is required, the mounting rod 306 may be pulled out with a slight force, making the disassembly very convenient.

Referring to FIGS. 1 to 5, the push rod head 304 is integrally provided with the mounting rod 306 to form a mushroom nail structure. The purpose is to make the structure more compact and simpler.

Referring to FIGS. 1 to 5, the push rod head 304 is provided with a rounded corner at an end away from the push rod piston 302.

Referring to FIG. 2, the hydraulic braking device is a symmetrical structure. The purpose is to enable the hydraulic braking device to be universally installed on the left and right shifters.

Referring to FIGS. 1 to 5, the push rod head 304 is a metal push rod head, and the piston is a plastic push rod piston. The purpose is that the metal push rod head enhances the wear resistance of the push rod head 304, and the plastic push rod piston makes the push rod piston 302 relatively soft in texture, which may prevent a cylinder wall of the cylinder body 301 from being damaged due to friction with the push rod piston 302.

Referring to FIGS. 1 to 5, the hydraulic braking device further includes a breather rubber 307 and a sealing cover 308, the cylinder body 301 is provided with an oil cylinder 309 and an oil compensation chamber 310; the oil compensation chamber 310 is in communication with the oil cylinder 309; and the push rod piston 302 is slidably connected with the oil cylinder 309. The breather rubber 307 is provided at the upper end of the oil compensation chamber 310; the sealing cover 308 is provided at the upper end of the breather rubber 307; the sealing cover 308 is fixedly connected to the cylinder body 301; and the sealing cover 308 is provided with a ventilation hole 311. The front end of the cylinder body 301 is provided with an oil filler hole 312, and the oil filler hole 312 is in communication with the oil compensation chamber 310. The opening of the oil filler hole 312 is provided with a sealing bolt 313, and the sealing bolt 313 is configured to install the sealing cover 308 on the cylinder body 301 and to seal the oil filler hole 312. The rear end of the cylinder body 301 and the sealing cover 308 are fixed by a fixing screw 314. The cylinder body 301 is symmetrically provided with two oil outlet holes 315; the two oil outlet holes 315 are in communication with the oil cylinder 309; and an outlet of the oil outlet hole 315 is sealed by a sealing member 317. The oil cylinder 309 and the oil compensation chamber 310 communicate with each other through an oil compensation hole 318 and a lubricating oil hole 319. In this embodiment, when the hydraulic braking device is installed on a bicycle, the sealing member 317 at the outlet of one of the oil outlet holes 315 is removed, and then a line 316 is installed on the outlet of the oil outlet hole 315. During braking, the push rod piston 302 moves within the oil cylinder 309 against the elastic force of the reset spring 303, pushing the hydraulic fluid within the oil cylinder 309 to move. The hydraulic fluid flows out through the oil outlet 315 into the line 316, and then enters a brake caliper through the line 316, driving the brake caliper to move and thus achieving braking. By providing the oil compensation chamber 310, the hydraulic fluid in the oil cylinder 309 may be compensated. By providing the ventilation hole 311, the pressure applied to the upper side of the breather rubber 307 is ensured to be atmospheric pressure, thereby accommodating changes in the volume of hydraulic fluid within the oil compensation chamber 310. By providing the oil filler hole 312, the hydraulic fluid may be replenished through the oil filler hole 312. By providing two oil outlet holes 315, the line 316 may be installed in the appropriate oil outlet hole 315 according to the different installation directions of shifters on the left and right ends of the bicycle. The hydraulic fluid entering the oil cylinder 309 through the lubricating oil hole 319 may serve to lubricate the push rod piston 302.

Referring to FIGS. 1 to 5, the structure of the sealing member 317 may be the same as the structure of the sealing bolt 313.

Referring to FIG. 3, the reset spring 303 is provided in the oil cylinder 309, with one end acting on the end of the oil cylinder 309, and the other end acting on the push rod piston 302.

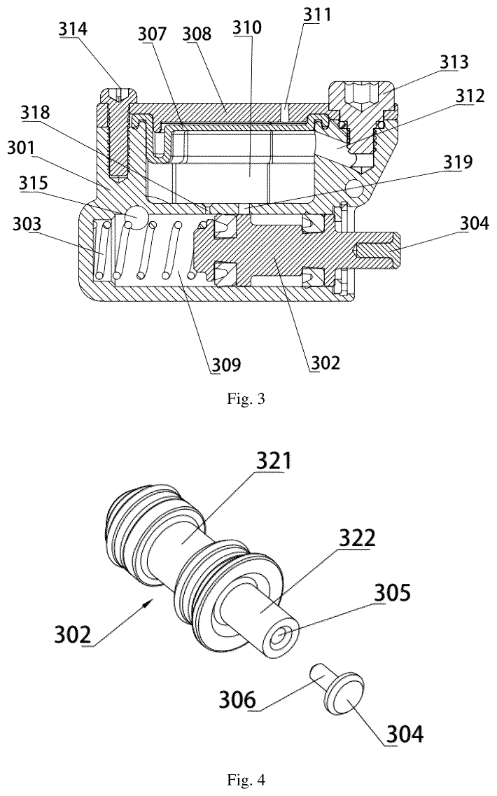

Referring to FIG. 3 and FIG. 4, the push rod piston 302 includes a piston portion 321 and a push rod portion 322. The piston portion 321 is slidably connected with the oil cylinder 309, and the push rod portion 322 is connected to the push rod head 304. The purpose is to make the structure more compact.

Referring to FIGS. 1 to 7, the working principle of the hydraulic braking device 3 for bicycle hydraulic braking is as follows.

During braking, the operating lever 2 rotates to drive a transmission component 4 to move, and the transmission component 4 contacts the push rod head 304. Alternatively, the operating lever 2 directly contacts the push rod head 304, driving the push rod head 304 and the push rod piston 302 to move together. The push rod piston 302 will move within the cylinder body 301 against the elastic force of the reset spring 303, pushing the hydraulic fluid within the cylinder body 301 to move, and the hydraulic fluid drives the brake caliper to move, thereby achieving braking.

In some embodiments, the detachable structure is a threaded connection structure. Through the threaded connection structure, it is very convenient to install and remove the push rod head 304 and the push rod piston 302. Moreover, after installation, the connection between the push rod head 304 and the push rod piston 302 is very stable.

The threaded connection structure includes a threaded hole provided on the push rod piston 302 and a threaded rod provided on the push rod head 304, and the threaded rod is in mating engagement with the threaded hole. By setting up the above structure, it is convenient for disassembly and assembly.

The axis of the threaded hole coincides with the axis of the push rod piston 302.

The push rod head 304 is integrally formed with the threaded rod to form a bolt. In the above structure, through direct bolt installation in the threaded hole, direct contact between the push rod piston 302 and the transmission component 4 or the operating lever 2 may be prevented. Additionally, the bolt is inexpensive, which further reduces both production and maintenance costs.

The position of the threaded hole is the same as the position of the mounting hole 305, and the position of the threaded rod is the same as the position of the mounting rod 306.

In some embodiments, the detachable structure may also be a bonding structure or a snap structure. By providing the bonding structure, the stability of installation may also be ensured, and the installation and disassembly are also very convenient. The bonding structure is a bonding element, and the push rod piston 302 is bonded to the push rod head 304 through the bonding element. The bonding element may be glue, double-sided tape, etc.

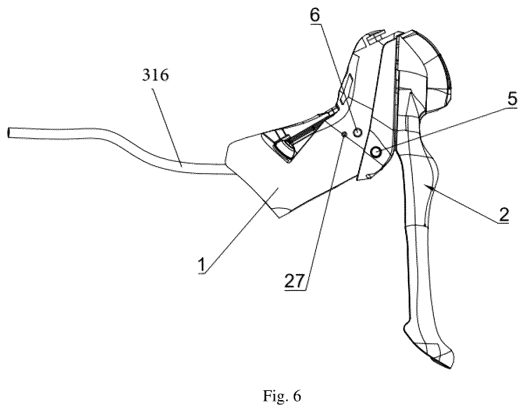

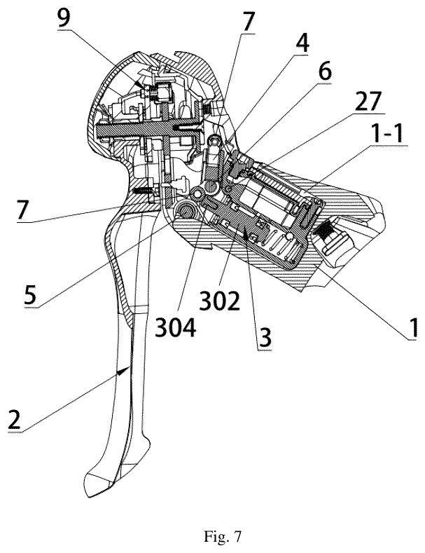

The bicycle of the present disclosure includes the hydraulic braking device 3 as described above. The bicycle further includes a handlebar. Shifters are provided at the left and right ends of the handlebar. As shown in FIG. 6 and FIG. 7, the shifter includes a support 1 and an operating lever 2. The support 1 is installed on the handlebar, and the operating lever 2 is hinged on the support 1. Referring to FIG. 6 and FIG. 7, the hydraulic braking device 3 is provided inside the support 1.

Referring to FIG. 6 and FIG. 7, the head of the operating lever 2 is integrated with a gear-shifting device 9, enabling bicycle speed-changing adjustment.

Referring to FIG. 6 and FIG. 7, the support 1 may be provided with a transmission component 4. The transmission component 4 is a driving rod and is rotatably connected to the support 1.

In some embodiments, the bicycle is a road bicycle.

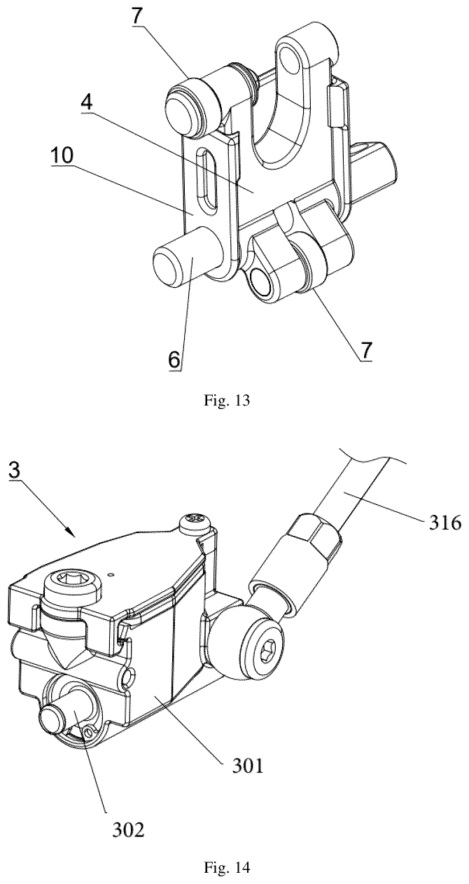

Now, the hydraulic braking operation device of the present disclosure will be described with reference to FIGS. 6 to 15.

Referring to FIGS. 6 to 11 and FIGS. 14 to 15, the hydraulic braking device 3 is a symmetrical structure. The purpose is to ensure that the hydraulic braking device 3 may be universally installed on the hydraulic braking operation devices (shifters) at the left and right ends of the road bicycle handlebar, reducing the complexity of manufacturing, enhancing the applicability of the hydraulic braking device 3, and reducing production costs.

Referring to FIGS. 6 to 11, the operating lever 2 is hinged to the front end of the support 1 through a brake shaft 5, and the driving rod 4 is rotatably connected to the support 1 through a mounting shaft 6.

Referring to FIG. 6 and FIG. 7, the hydraulic braking device 3 is connected to a braking equipment of a wheel through the line 316. The hydraulic fluid is delivered through the line 316 to form a braking hydraulic fluid circuit. The braking equipment is a brake caliper.

Referring to FIGS. 6 to 13, the driving rod 4 is rotatably provided on the support 1; the head end and the tail end of the driving rod 4 are each provided with a rolling member 7; the rolling member 7 at the head end is in contact with the operating lever 2; and the rolling member 7 at the tail end is in contact with the hydraulic braking device 3. By providing the rolling members 7, the driving rod 4 moves smoother when the operating lever 2 performs a braking action, ensuring smooth braking operation.

Referring to FIGS. 6 to 13, the rolling member 7 is a rolling bearing. In the above structure, the rolling bearing may greatly reduce the friction between the driving rod and the operating lever, and between the driving rod and the hydraulic braking device 3, ensuring smoother movement of the driving rod 4.

Referring to FIGS. 6 to 13, the rolling member 7 may also be a shaft sleeve.

Referring to FIGS. 6 to 10, the head of the operating lever 2 is provided with a speed-changing operation device 9. In the above structure, by providing the speed-changing operation device 9, gear shifting may be achieved, thereby enabling a speed-changing operation of the road bicycle. The hydraulic braking device 3 is provided inside the support 1, and the speed-changing operation device 9 is provided on the head of the operation lever 2, so that the hydraulic braking device 3 and the speed-changing operation device 9 are provided independently of each other. Compared with the prior art, where both the hydraulic braking device and the speed-changing operation device are provided on the head of the operation lever, the structure of the present disclosure becomes simpler and smaller in volume. The specific structure of the speed-changing operation device 9 may refer to the prior art disclosed in a utility model patent with publication number CN 205256577 U.

Referring to FIGS. 6 to 11, the operating lever 2 includes a base 2-1 and a lever body 2-2. The base 2-1 is rotatably provided on the support 1 through the brake shaft 5, and the lever body 2-2 is rotatably provided on the base 2-1. The rolling member 7 at the head end of the driving rod 4 is in contact with the base 2-1. In the above structure, during braking, when the lever body 2-2 is gripped, the lever body 2-2 and the base 2-1 rotate together around the support 1. The base 2-1 drives the driving rod 4 to move, causing the rolling member 7 at the tail end of the driving rod 4 to activate the hydraulic braking device 3. During gear shifting, by manipulating the lever body 2-2, the lever body 2-2 rotates around the base 2-1, driving the speed-changing operation device 9 to move, thereby achieving the gear-shifting operation.

Referring to FIGS. 6 to 11, the base 2-1 is provided with an extended drive portion 2-11, and the extended drive portion 2-11 is in contact with the rolling member 7 at the head end of the driving rod 4. By providing the extended drive portion 2-11, during braking, the base 2-1 rotates on the support 1, and the extended drive portion 2-11 rotates together with the base 2-1. The extended drive portion 2-11 pushes the rolling member 7 at the head end, driving the movement of the driving rod 4, thereby activating the hydraulic braking device 3.

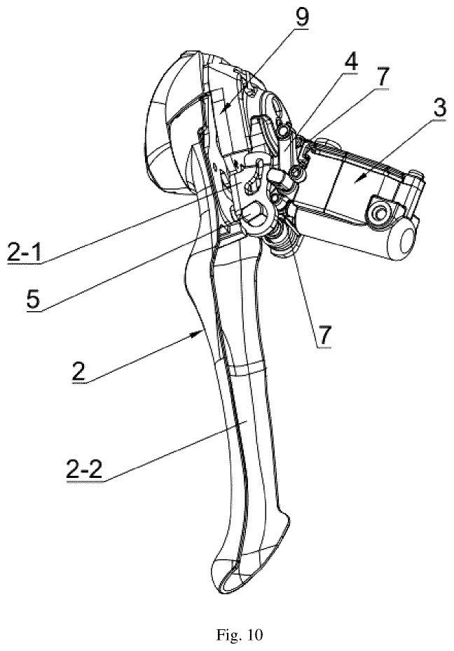

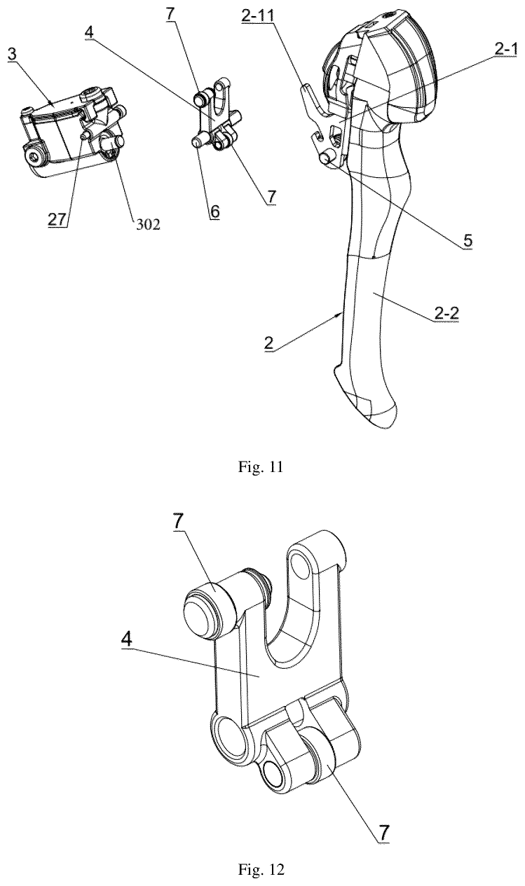

Referring to FIG. 12 and FIG. 13, the driving rod 4 is in a V-shape, and the mounting shaft 6 passes through a bent corner portion of the V-shape driving rod 4. The purpose is to make the structure of the driving rod 4 more compact, thereby facilitating the installation of the driving rod 4 into the support 1 and simultaneously achieving more efficient actuation of the hydraulic braking device 3.

Referring to FIG. 12 and FIG. 13, the driving rod 4 is a symmetrical structure. The head end of the driving rod 4 has a U-shaped structure. Both sides of the U-shaped structure are each provided with a hole for installing the rolling member 7. The purpose is that the rolling members 7 may be installed on the different sides of the U-shaped structure according to the different installation directions of the hydraulic braking operation devices at the left and right ends of the road bicycle, thereby improving the applicability of the driving rod 4.

Referring to FIG. 12 and FIG. 13, a sleeve 10 sleeves on the outside of the driving rod 4, and the purpose is to improve the strength of the driving rod 4.

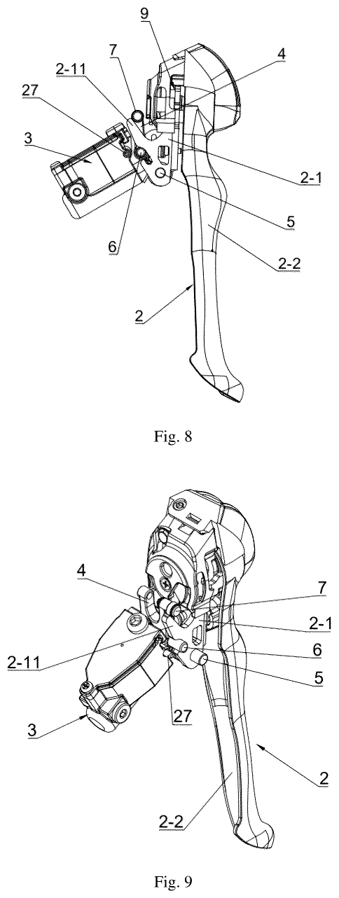

Referring to FIG. 8 and FIGS. 12 to 13, the extended drive portion 2-11 passes through a space between the rolling member 7 at the head end and the mounting shaft 6 and extends to the rear of the rolling member 7 at the head end. The purpose is to make the structure more compact. Taking FIG. 8 as a rotation reference, during braking, the base 2-1 rotates clockwise on the support 1. The extended drive portion 2-11 on the base 2-1 rotates clockwise accordingly. This rotation of the extended drive portion 2-11 pushes the rolling member 7 at the head end, driving the driving rod 4 to rotate clockwise accordingly. The rolling member 7 at the tail end of the driving rod 4 then activates the hydraulic brake device 3.

Referring to FIGS. 6 to 11, the support 1 is provided with an installation inner cavity 1-1. The hydraulic braking device 3 is fixed in the installation inner cavity 1-1 through a positioning shaft 27. In the above structure, installing the hydraulic braking device 3 in the installation inner cavity 1-1 may make the entire structure of the hydraulic braking operation device more compact. The hydraulic braking device 3 may be installed in the installation inner cavity 1-1 from front to back or from top to bottom. The rear end of the installation inner cavity 1-1 may restrict the hydraulic braking device 3, while the front end is fixed through the positioning shaft 27. The fixing method is extremely simple.

Referring to FIG. 7 and FIGS. 14 to 15, the hydraulic braking device 3 includes a cylinder body 301, a push rod piston 302, and a reset spring 303. An oil cylinder 309 is provided in the cylinder body 301, and the push rod piston 302 reciprocates in the oil cylinder 309 by overcoming an elastic force of the reset spring 303. The rolling member 7 at the tail end of the driving rod 4 is in contact with the push rod piston 302. In the above structure, during braking, the operating lever 2 drives the driving rod 4 to move, and the rolling member 7 at the tail end of the driving rod 4 drives the push rod piston 302 to move. The push rod piston 302 moves within the oil cylinder 309 against the elastic force of the reset spring 303, driving the hydraulic fluid within the oil cylinder 309 to move. The hydraulic fluid enters the braking equipment (i.e. the brake caliper) through the line 316, thereby driving the braking equipment (i.e. the brake caliper) on the wheel of the road bicycle to move and thus achieving braking. After braking is completed, the push rod piston 302 is returned by the elastic force of the reset spring 303.

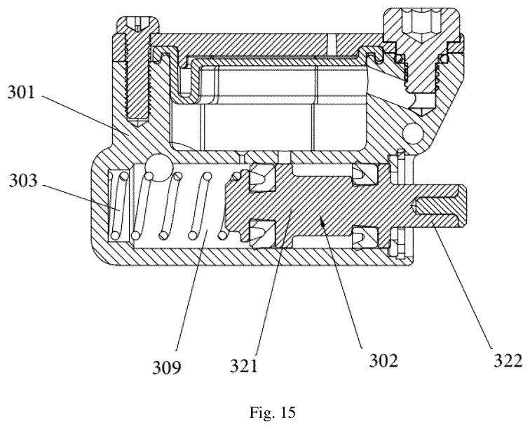

Referring to FIG. 15, the push rod piston 302 includes a piston portion 321 and a push rod portion 322. The piston portion 321 is movably connected to the oil cylinder 309, and the rolling member 7 at the tail end of the driving rod 4 is in contact with the push rod portion 322.

Referring to FIGS. 6 to 12, the working principle of the hydraulic braking operation device for the road bicycle is as follows.

During braking, the operating lever 2 is gripped. The operating lever 2 rotates around the support 1, and the driving force of the operating lever 2 is transmitted to the driving rod 4, driving the driving rod 4 to move. The moving driving rod 4 then activates the hydraulic brake device 3, achieving braking of the road bicycle.

The present disclosure also relates to a bicycle that includes the above-mentioned hydraulic braking operation device. There are two hydraulic braking operation devices, which are respectively provided at the left and right ends of the handlebar.

The above-mentioned implementations are preferred implementations of the present disclosure, but the implementations of the present disclosure are not limited by the above content. Any other changes, modifications, substitutions, combinations, and simplifications made without departing from the spirit and principle of the present disclosure should be equivalent replacements and are included in the scope of the present disclosure.

1. A hydraulic braking device for bicycle, comprising a cylinder body, a push rod piston, and a reset spring; wherein one end of the push rod piston reciprocates in the cylinder body by overcoming an elastic force of the reset spring; and a push rod head is provided on another end of the push rod piston;
wherein the push rod head and the push rod piston are connected through a detachable structure, and the detachable structure is one of an interference fit structure, a threaded connection structure, or a bonding structure.

2-3. (canceled)

4. The hydraulic braking device for bicycle according to claim 1, wherein when the detachable structure is the interference fit structure, the interference fit structure comprises a mounting hole provided on the push rod piston and a mounting rod provided on the push rod head, and the mounting hole is in an interference fit with the mounting rod.

5. The hydraulic braking device according to claim 4, wherein the push rod head is integrally provided with the mounting rod.

6. The hydraulic braking device according to claim 13, wherein when the detachable structure is the threaded connection structure, the threaded connection structure comprises a threaded hole provided on the push rod piston and a threaded rod provided on the push rod head, and the threaded rod is in mating engagement with the threaded hole.

7. The hydraulic braking device according to claim 1, wherein the hydraulic braking device is a symmetrical structure.

8. The hydraulic braking device according to claim 1, wherein the push rod head is a metal push rod head, and the piston is a plastic push rod piston.

9. The hydraulic braking device according to claim 1, wherein the hydraulic braking device further comprises a breather rubber and a sealing cover; the cylinder body is provided with an oil cylinder and an oil compensation chamber; the oil compensation chamber is in communication with the oil cylinder; and the push rod piston is slidably connected with the oil cylinder; the breather rubber is provided at an upper end of the oil compensation chamber; the sealing cover is provided at an upper end of the breather rubber; the sealing cover is fixedly connected to the cylinder body; and the sealing cover is provided with a ventilation hole; the front end of the cylinder body is provided with an oil filler hole; the oil filler hole is in communication with the oil compensation chamber; an opening of the oil filler hole is provided with a sealing bolt; the sealing bolt is configured to install the sealing cover on the cylinder body and to seal the oil filler hole; a rear end of the cylinder body and the sealing cover are fixed by a fixing screw; the cylinder body is symmetrically provided with two oil outlet holes; the two oil outlet holes are in communication with the oil cylinder; an outlet of the oil outlet hole is sealed by a sealing member; and the oil cylinder and the oil compensation chamber communicate with each other through an oil compensation hole and a lubricating oil hole.

10. A bicycle hydraulic braking operation device, comprising a support, an operating lever, and the hydraulic braking device according to claim 1; wherein
the operating lever is rotatably connected to the support; the hydraulic braking device is a symmetrical structure and is provided inside the support; a driving rod is provided on the support; a head end of the driving rod is in contact with the operating lever; a tail end of the driving rod is in contact with the hydraulic braking device; and
the driving rod is configured to receive a driving force from the operating lever.

11. The hydraulic braking operation device according to claim 10, wherein the driving rod is rotatably provided on the support; the head end and the tail end of the driving rod are each provided with a rolling member; the rolling member at the head end is in contact with the operating lever; and the rolling member at the tail end is in contact with the hydraulic braking device.

12. The hydraulic braking operation device according to claim 11, wherein the rolling member is a rolling bearing.

13. The hydraulic braking operation device according to claim 10, wherein a head of the operating lever is provided with a speed-changing operation device.

14. The hydraulic braking operation device according to claim 11, wherein the operating lever comprises a base and a lever body; the base is rotatably provided on the support; the lever body is rotatably provided on the base; and the rolling member at the head end of the driving rod is in contact with the base.

15. The hydraulic braking operation device according to claim 14, wherein the base is provided with an extended drive portion, and the extended drive portion is in contact with the rolling member at the head end of the driving rod.

16. The hydraulic braking operation device according to claim 10, wherein the support is provided with an installation inner cavity; and the hydraulic braking device is fixed in the installation inner cavity through a positioning shaft.

17. The hydraulic braking operation device according to claim 10, wherein the tail end of the driving rod is in contact with the push rod piston.

18. A bicycle, comprising the hydraulic braking device according to claim 1.

19. A bicycle, comprising the hydraulic braking operation device according to claim 10.
